(19) United States
(12) Patent Application Publication
(10) Pub. No.: US 2018/0209052 A1
(43) Pub. Date: Jul. 26, 2018

(54) TUBE CELL-BASED PRESSURE-TYPE COELECTOLYSIS MODUDE

(71) Applicant: KOREA INSTITUTE OF ENERGY RESEARCH, Daejeon (KR)

(72) Inventors: Tak-hyoung LIM, Daejeon (KR); Rak-hyun SONG, Seoul (KR); Seok-joo PARK, Daejeon (KR); Seung-bok LEE, Daejeon (KR); Jong-won LEE, Daejeon (KR)

(21) Appl. No.: 15/322,136

(22) PCT Filed: Nov. 10, 2015
(86) PCT No.: PCT/KR2015/012076

§ 371 Date: Dec. 26, 2016

(30) Foreign Application Priority Data
Apr. 30, 2015 (KR) 10-2015-0061463

(51) Int. Cl. C25B 1/12; C25B 15/02; C25B 9/10; C25B 11/04

(52) U.S. Cl. CPC C25B 1/12; C25B 15/02; G05D 7/0682; C25B 11/0426; C25B 9/10

(57) ABSTRACT

The present invention relates to a coelectrolysis module which can produce synthesis gas from water and carbon dioxide and, more particularly, to a pressure coelectrolysis module having a tube-type cell mounted thereon. The pressure coelectrolysis module according to the present invention comprises a coelectrolysis cell which uses fuel gas consisting of hydrogen, nitrogen, and carbon dioxide; a pressure chamber for pressurizing the coelectrolysis cell; a vaporizer for providing steam to the coelectrolysis cell; and a mass flow controller for providing fuel gas to the coelectrolysis cell, wherein the pressure coelectrolysis module has excellent performance and durability and can improve the production yield of synthesis gas.

### CROSS-REFERENCE TO RELATED APPLICATIONS

This patent application is a national-stage application of International Patent Application No. PCT/KR2015/012076 filed on Nov. 10, 2015, which claims priority under 35 U.S.C. § 119 to Korean Patent Application No. 102015-0061463, filed on Apr. 30, 2015, in the Korean Intellectual Property Office, the disclosure of which is incorporated by reference herein in its entirety.

### TECHNICAL FIELD

The present invention relates to a co-electrolysis module capable of producing syngas from water and carbon dioxide, and more specifically to, a pressure co-electrolysis module including a tube-type cell mounted thereon, haying excellent performance and durability and capable of improving the production yield of syngas.

### DISCUSSION OF RELATED ART

Various policies have been suggested to reduce carbon emissions in the world according to the Kyoto Protocol adopted in 1997, and techniques of reducing the generation of carbon dioxide have been developed in various aspects.

In an aspect to develop a fuel that does not emit carbon dioxide in order to essentially prevent release of carbon dioxide, techniques for generating electricity by having a hydrogen fuel react with oxygen in the air have been developed, and vehicles utilizing motors using hydrogen as a fuel are widely known.

Meanwhile, there is ongoing research and development related to the process of converting into a usable fuel by using carbon dioxide previously generated. More attention is directed to production of hydrogen by CO₂-based high-temperature electrolysis as well as recent green energy technologies and renewable energy research and development.

A high temperature electrolysis system is an apparatus to inject carbon dioxide and steam to a cathode and air to an anode and to produce syngas by electrolysis reaction when applying electricity while maintaining a high temperature. Although the technology to produce syngas by CO₂—H₂0 high temperature electrolysis reaction improves reaction efficiency by combining reaction and separation processes to allow for a simplified process and increased throughput that leads to an efficient operation, high temperature electrolysis technology for carbon dioxide has been limitedly developed in the research focusing on noble metal electrodes.

The co-electrolysis cell to produce syngas by CO₂—H₂O high temperature electrolysis has a problem with commercialization due to a low syngas conversion rate of CO₂ and poor efficiency. Thus, needs exist for a co-electrolysis cell and a co-electrolysis module with a good conversion rate as compared with those adopted in conventional high temperature electrolysis reaction systems.

### SUMMARY

An object of the present invention is to provide a co-electrolysis module for operating with pressure, having an excellent syngas conversion rate.

Further, an object of the present invention is to a co-electrolysis module adopting a tube cell having excellent performance and durability to have excellent durability although pressurizing and operating it.

In order to achieve the above objects, the present invention is to provide a pressure-type co-electrolysis module, comprising a co-electrolysis cell using a fuel gas comprising hydrogen, nitrogen, and carbon dioxide, a pressurized chamber for pressurizing the co-electrolysis cell, and an evaporator for providing steam with the co-electrolysis cell.

The pressure-type co-electrolysis module may comprise a mass flow rate controller capable of controlling a mass flow rate of each of the hydrogen, the nitrogen, and the carbon dioxide.

The co-electrolysis cell may be used as a tube-type co-electrolysis cell, and the tube-type co-electrolysis cell may comprise a cylindrical support, a cathode layer formed on a surface of the cylindrical support, a solid electrolyte layer formed on a surface of the cathode layer, and an anode layer formed on a surface of the solid electrolyte layer.

Here, the cathode layer may comprise (Sr₁₋ₓLaₓ)(Ti_{1-y}M_{y})O₃ (M=V, Nb, Co, Mn).

The module may comprise a heating device for heating the tube-type co-electrolysis cell inside the pressurized chamber.

The module may comprise a differential pressure adjustment system for adjusting a differential pressure between the tube-type co-electrolysis cell and the pressurized chamber.

The differential pressure adjustment system may comprise a first valve provided in an air injecting part for injecting air to an inner part of the pressurized chamber, a pressure gauge provided in an air exhausting part for exhausting air from the pressurized chamber, a pressure adjustor provided between the air injecting part and the air exhausting part, a second valve provided in a fuel injecting part for injecting the fuel gas and steam to the co-electrolysis cell, a differential pressure gauge measuring a differential pressure between the air exhausting part and an exhausting part of the co-electrolysis cell for exhausting gas from the co-electrolysis cell after reaction, and a differential pressure adjustor connected to the second valve.

The module may further comprise buffer chamber provided in the exhausting part of the co-electrolysis cell.

A pressure of the pressurized chamber may be adjusted using the pressure adjustor, and the differential pressure between the pressurized chamber and the co-electrolysis cell may be adjusted using the differential pressure adjustor.

The first valve may be adjusted so that the pressure of the pressurized chamber is 4 bar to 10 bar.

The second valve may be adjusted so that the differential pressure between the pressurized chamber and the co-electrolysis cell is 0.3 bar or less.

Further, the present invention is to provide a method of operating, under pressure, the pressure-type co-electrolysis module comprising measuring a pressure of the pressure gauge, setting pressure of the pressure adjustor, adjusting the first valve according to the set pressure, setting, a differential pressure of the differential pressure adjustor, and adjusting the second valve according to the set differential pressure.

The pressure of the pressure adjustor may be set to 4 bar to 10 bar, and the differential pressure of the differential pressure adjustor is set to 0.3 bar or less.

The pressure-type co-electrolysis module of the present invention may have an excellent conversion rate.

The pressure-type co-eleorolysis module adopts a tube-type cell, although pressurizing and operating it, to be able to have excellent durability.

### BRIEF DESCRIPTION OF THE DRAWINGS

FIG. 1 is a view illustrating a pressure-type co-electrolysis module according to an embodiment of the present invention;

FIG. 2 is a view illustrating a tubular co-electrolysis cell applied to a pressure-type co-electrolysis module according to an embodiment of the present invention;

FIG. 3 is a view illustrating an inner part of a pressurized chamber according to an embodiment of the present invention;

FIG. 4 is a view illustrating a configuration of a pressurized chamber according to an embodiment of the present invention;

FIG. 5 is a graph illustrating the temperature of an inner part of a pressurized chamber and a co-electrolysis cell upon operating a pressure-type co-electrolysis module according to an embodiment of the present invention;

FIG. 6 is a graph illustrating a differential pressure between an inner part of a pressurized chamber and a co-electrolysis cell while a pressure-type co-electrolysis module according to an embodiment of the present invention is operated;

FIG. 7 is a graph illustrating each pressure of a pressurized chamber and an inner part of a co-electrolysis cell upon operating a pressure-type co-electrolysis module according to an embodiment of the present invention;

FIG. 8 is a graph illustrating the flow rate of fluids supplied to a pressurized chamber and an electrode of a co-electrolysis cell upon operating a pressure-type co-electrolysis module according to an embodiment of the present invention; and

FIG. 13 is a graph illustrating a result of operations upon operating, under different pressures, a pressure-type co-electrolysis module according to an embodiment of the present invention.

### DETAILED DESCRIPTION OF EXEMPLARY EMBODIMENTS

Hereinafter, the present invention will be described in detail with reference to the accompanying drawings. The terms or words used in the present disclosure should not be limited as construed in typical or dictionary meanings, but rather to comply with the technical concept of the present invention.

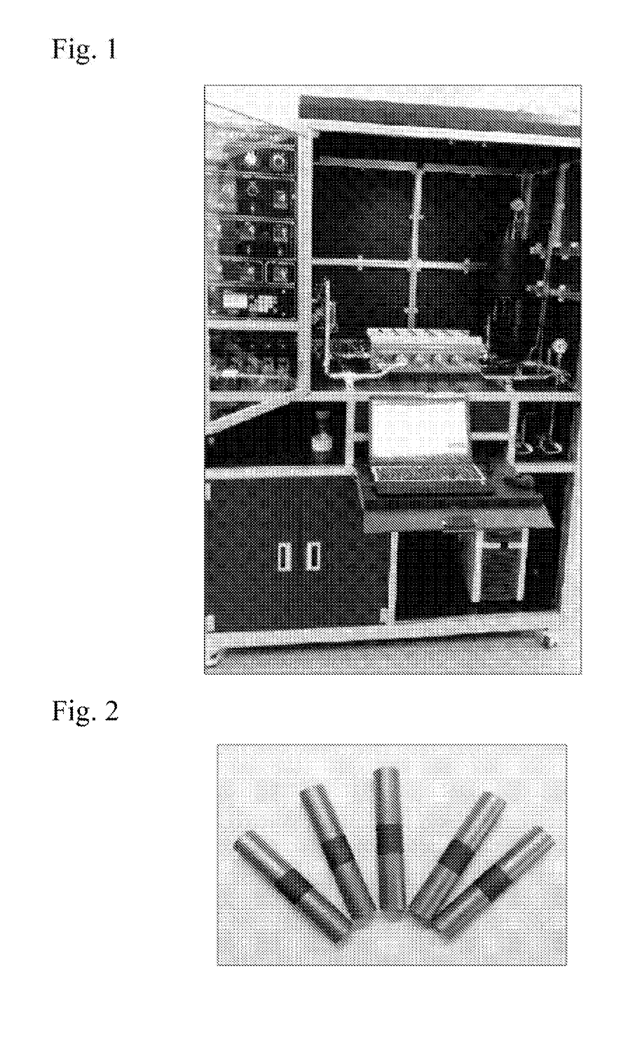

Referring to FIG. 1, a pressure-type co-electrolysis module according to an embodiment of the present invention comprises a co-electrolysis cell using a fuel gas comprising hydrogen, nitrogen, and carbon dioxide, a pressurized chamber for pressing the co-electrolysis cell, an evaporator providing steam to the co-electrolysis cell, and a mass flow rate controller for providing the fuel gas to the co-electrolysis cell.

A co-electrolysis cell is an apparatus to produce syngas by electrolysis occurring when applying electricity to an anode and cathode while maintaining a high temperature, with carbon dioxide and steam injected into the cathode and air into the anode. Such co-electrolysis cell is a new renewable energy generating apparatus capable of obtaining a reusable fuel from carbon dioxide.

As shown in FIG. 2, the co-electrolysis cell is preferably a tube-type co-electrolysis cell maintaining excellent durability although operating the co-electrolysis cell under pressure.

Specifically, the, co-electrolysis cell comprises a cylindrical support, a cathode layer formed on a surface of the cylindrical support, a solid electrolyte layer formed on a surface of the cathode layer, and an anode layer formed on a surface of the solid electrolyte layer.

The support may be, but is not limited to, a cermet of NIO and YSZ that are respectively nickel (NIO)/yttria stabilized zirconia (YSZ).

The cathode may adopt, but is not limited to, Ni-YSZ that is a metal-ceramic composite, LSCM ((La_{0.75}, Sr_{0.25})_{0.95}Mn_{0.5}Cr_{0.5}O₃) as a perovskite-based ceramic cathode, or (Sr₁₋ₓLaₓ)(Ti_{1-y}M_{y})O₃ (M=V, Nb, Co, Mn) as a LST-based ceramic cathode.

In particular, it is preferred to use (Sr₁₋ₓLaₓ)(Ti_{1-y}M_{y})O₃ (M=V, Nb, Co, Mn) as the cathode. The LST type ceramic cathode, (Sr₁₋ₓLaₓ)(Ti_{1-y}M_{y})O₃ (M=V, Nb, Co, Mn may remain at constant conductivity and mechanical strength because it does not generate redox cycling due to excellent redox resistance even at a high concentration of H₂O in fuel.

As the anode, one typically known in the art to which the present invention pertains may be used, including, but not limited to, e.g., LSCF-GDC, YSZ/LSM, and LSM composite.

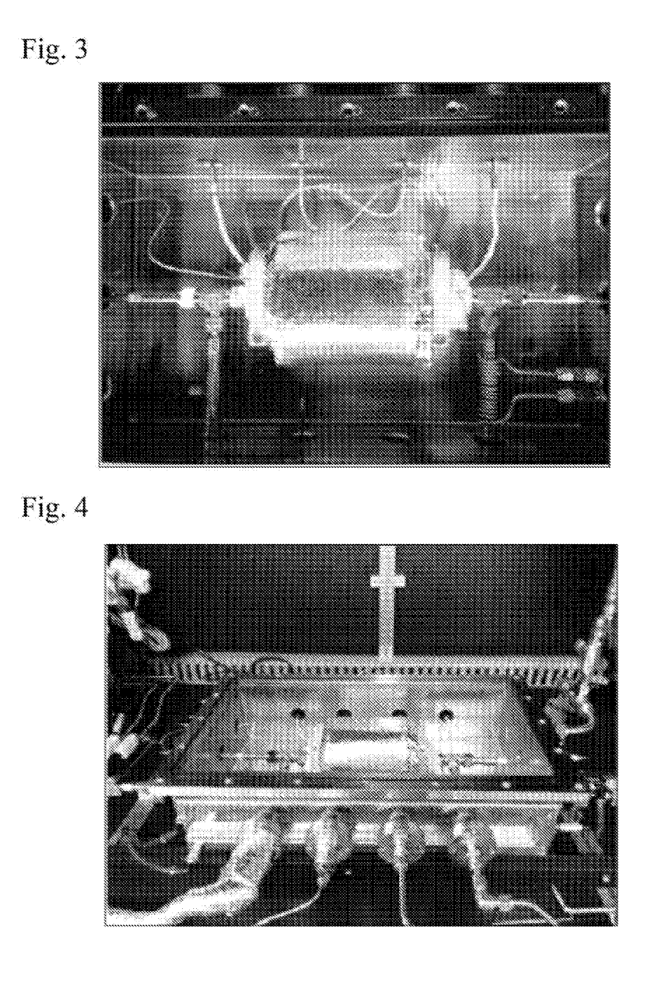

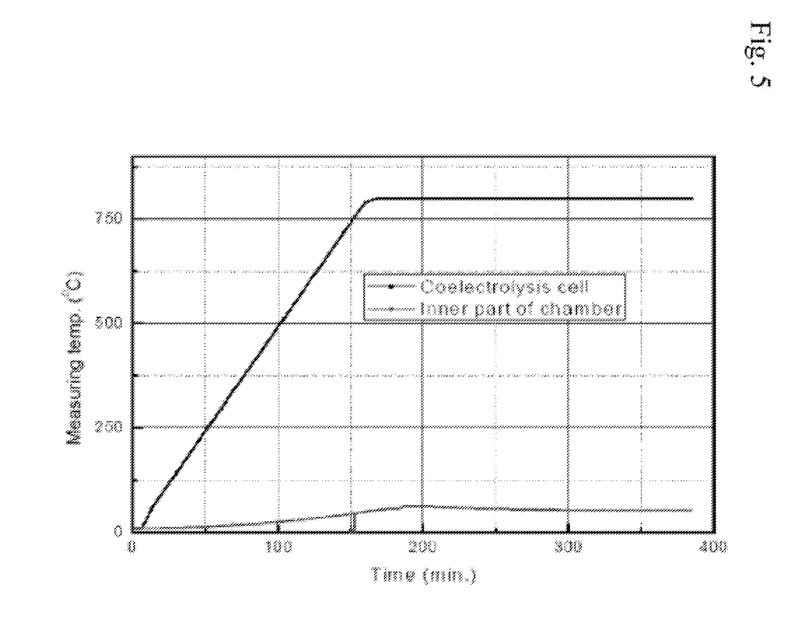

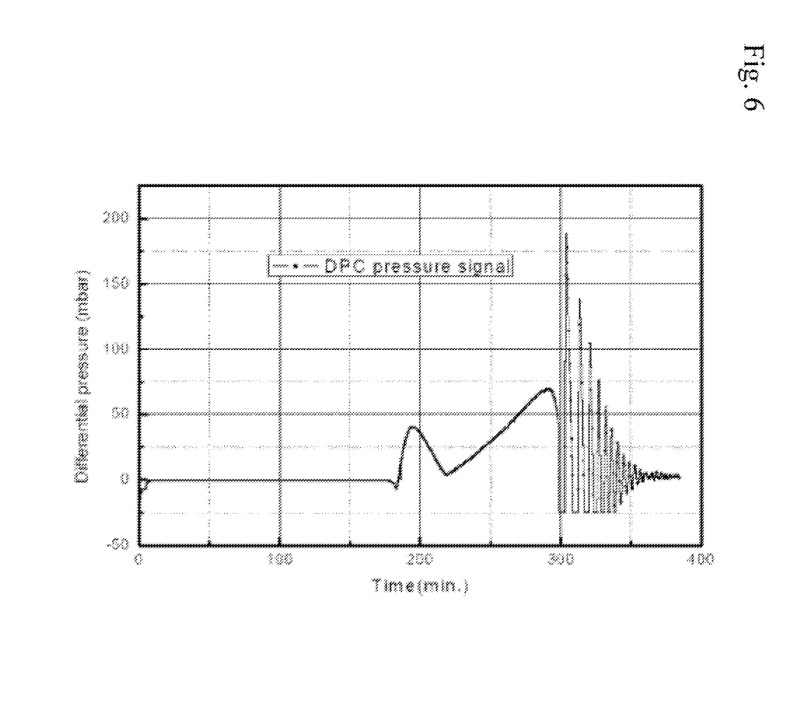

As shown in FIGS. 3 and 4, the pressurized chamber further comprises a heating device for heating the tube-type co-electrolysis cell therein.

The heating device may heat the co-electrolysis cell so that the co-electrolysis cell a temperature of 500° C. to 1000° C.

The heating device may be, but is not limited to, a heating device, for example, in which a quartz tube is surrounded by heating lines and an asbestos-insulation is used to minimize thermal loss.

The pressurized chamber comprises a fuel gas supplying feedthrough for providing the fuel gas and the steam to the tube-type co-electrolysis cell and a fuel gas exhausting feedthrough for exhausting a substance generated after reaction in the tube-type co-electrolysis cell and an unreacted substance from the tube-type co-electrolysis cell.

Further, the pressurized chamber comprises an air supplying feedthrougb for supplying air to the tube-type co-electrolysis cell and an air exhausting feedthrough for exhausting unreacted air.

Moreover, the pressurized chamber comprises a pair of feedthroughs for electricity collection inside the tube-type co-electrolysis cell and a pair of feedthroughs for electricity collection outside the tube-type co-electrolysis cell.

Lastly, the pressurized chamber comprises a pair of heating line feedthroughs supplying energy to the heating device.

Here, the fuel gas supplying feedthrough and one feedthrough for electricity collection inside the tube-type co-electrolysis cell may preferably be installed using a T-shaped tube, and the fuel gas exhausting feedthrough and the other feedthrough for electricity collection inside the tube-type co-electrolysis cell may preferably be installed using a T-shaped tube, which is, however, a description of one preferable embodiment. How the feedthroughs are installed inside the pressurized chamber is not limited thereto.

The pressurized chamber is preferably assembled using a metal fitting at each connecting pan to completely seal the inner part of the pressurized chamber. Upon assembly, a step for checking whether the gas is leaked at the each connecting part is preferably performed. Finally, the pressurized chamber, after closed with its cover, is sealed at high pressure and insulated.

The fuel gas injected into the cathode of the tube-type co-electrolysis cell comprises hydrogen, nitrogen, carbon dioxide, and steam. The pressure-type co-electrolysis module includes the mass flow rate controller capable of adjusting the flow rate of each fluid supplied.

Here, hydrogen and nitrogen, other than carbon dioxide, used as a fuel are inserted as stabilizing gas, and the injection of the stabilizing gas may lead to a co-electrolysis reaction with durability of the tube-type co-electrolysis maintained.

Among tubes for supplying the fuel gas to the cathode of the tube-type co-electrolysis cell, a hydrogen supplying tube, a nitrogen supplying tube, and a carbon dioxide supplying tube meet at their respective rear ends, generating a mixed gas of hydrogen, nitrogen, and carbon dioxide.

The mixed gas is blended with steam vaporized and exhausted from the vaporizer, forming a fuel gas, The fuel gas may be supplied to the cathode of the tube-type co-electrolysis cell.

The pressure-type co-electrolysis module according to the present invention is formed so that the pressure at which the mixed gas of hydrogen, nitrogen, and carbon dioxide is supplied to the cathode and the pressure at which air is supplied to the pressurized chamber are more than 1, allowing an inner part of the co-electrolysis cell and an outer part of the co-electrolysis cell, i.e., an inner part of the pressurized chamber, are configured to be pressurized at the same time.

As described above, the inner part and the outer part of the co-electrolysis cell are configured to be pressurized at the same time so that a yield of syngas by the co-electrolysis reaction may be increased.

To maintain durability of the co-electrolysis cell while increasing the yield of syngas, the pressure applied to an inner part and an outer part of the cell needs to be adjusted so that the co-electrolysis cell itself is subject to a zero-pressure. Thus, the pressure-type co-electrolysis module according to the present invention comprises a differential pressure adjustment system.

The differential pressure adjustment system comprises a first valve provided in an air injecting part; a pressure gauge provided in an air exhausting part; a pressure adjustor provided between the air injecting part and the air exhausting part; a second valve provided in a fuel injecting part of the co-electrolysis cell; a differential pressure gauge measuring a differential pressure provided between an exhausting part of the co-electrolysis cell and the air exhausting part; and a differential pressure adjustor connected to the second valve.

Steps for adjusting differential pressure is as follows.

First, the pressure of air coming out through the pressurized chamber is measured by the pressure gauge provided in the air exhausting part.

Based on the measured pressure, the pressure adjustor provided between the air injecting part and the air exhausting part is set to 4 bar to 10 bar, and the pressure of the pressurized chamber is adjusted to the set pressure using the first valve provided in the air injecting part.

Then, the differential pressure gauge and the differential pressure adjustor connecting the second valve provided in the fuel injecting part of the co-electrolysis cell are adjusted so that a differential pressure measured by the differential pressure gauge measuring differential pressure between the exhausting part of the co-electrolysis and the air exhausting part is 0.3 bar or less.

The present invention uses the above-described configuration to be able to adjust the pressure of the fuel gas supplied to the inner part of the co-electrolysis cell to be the same as the pressure of the air supplied to the pressurized chamber to be same.

In the pressure-type co-electrolysis module of the present invention, comparison between the volume of the co-electrolysis cell and the volume of the pressurized chamber reveals that the volume of the pressurized chamber is far bigger than the volume of the co-electrolysis cell. Such difference in volume renders the adjustment of differential pressure difficult, and raises a problem upon adjustment of differential pressure. The pressure-type co-electrolysis module of the present invention may comprise a buffer chamber for addressing the volume difference.

The buffer chamber is preferably positioned at a rear end of the exhausting part of the co-electrolysis cell.

Meanwhile, as set forth above, the pressurized chamber of the pressure-type co-electrolysis module according to the present invention is configured to be completely sealed, and thus a safety device for preventing risk due to pressure ma further be installed thereon.

As an example of the safety device, a device may be used which locks up all the gas supplying lines upon detecting a predetermined concentration or higher of hydrogen, carbon monoxide, and carbon dioxide in the pressurized chamber.

There may alternatively be used a device that puts a lock on all of the gas supplying lines when the pressure read by the pressure gauge in the air exhausting part is greater than 10 bar or the pressure of the differential pressure gauge measuring, a differential pressure between the exhausting part of the co-electrolysis cell and the air exhausting part is greater than 0.3 bar.

As another example, the pressure module may have a rupture disk installed thereon, to reduce pressure when the pressure inside the pressure module exceeds 10 bar.

Meanwhile, the pressure-type co-electrolysis module of the present invention comprises a flow rate gauge measuring a fuel gas supplied to the co-electrolysis cell and air supplied to the pressurized chamber, a pressure gauge measuring the pressure of steam supplied to the co-electrolysis cell, the pressure of the co-electrolysis, and the pressure of the pressurized chamber, and may further comprise a monitoring system checking, e.g., the pressure, low rate, or voltage at each point.

### EMBODIMENTS

After setting up, as described above, the pressure co-electrolysis module adopting the tube-type cell according to an embodiment of the present invention, the heating device was operated to enable the temperature of the tube-type co-electrolysis cell to be 750° C., differential pressure was adjusted by the differential pressure adjustment system, and the results were illustrated in FIGS. 5 to 8.

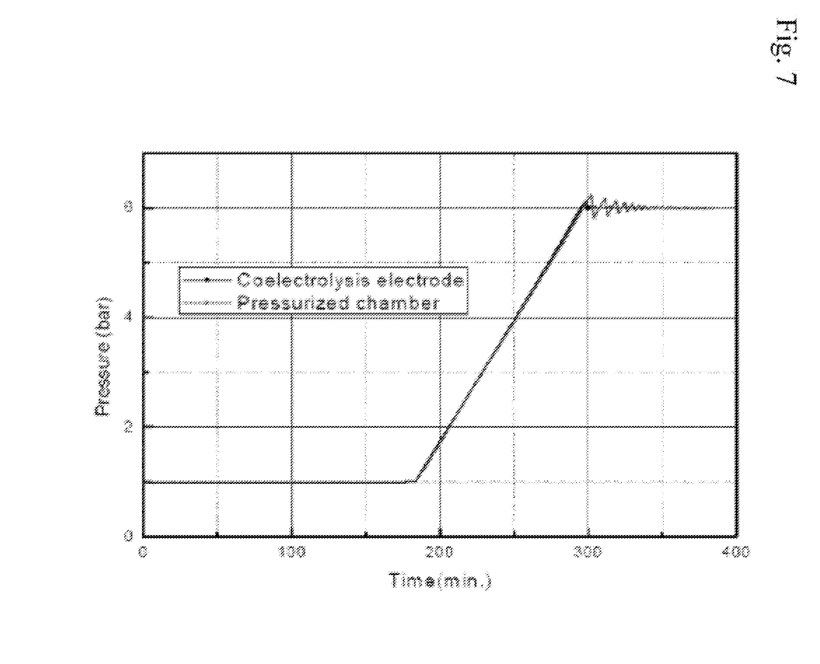

After operation of the pressure-type co-electrolysis module according to an embodiment of the present invention was initiated, changes in temperature of the inner part of the pressurized chamber and the co-electrolysis cell were illustrated in FIG. 5, and changes in differential pressure between the pressurized chamber and the co-electrolysis cell were illustrated in FIG. 6.

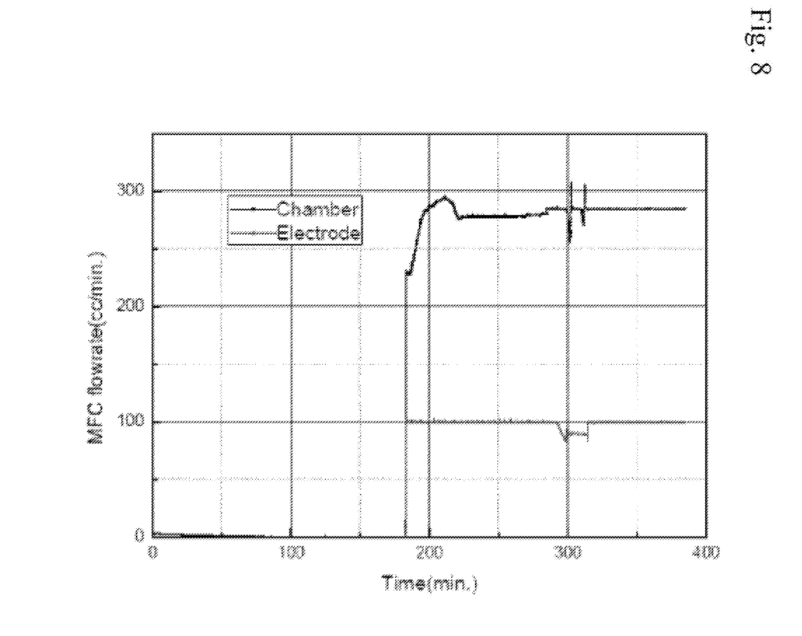

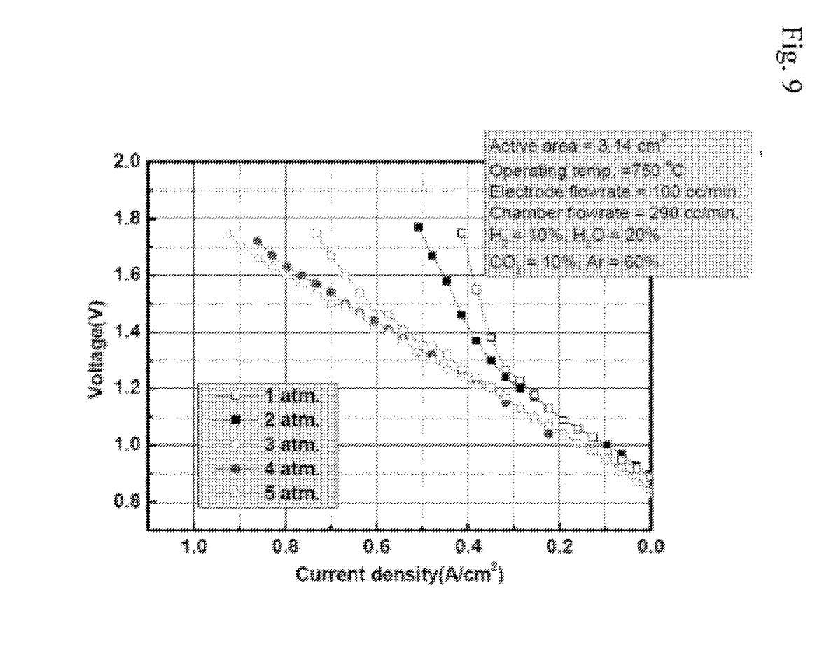

Further, after operation of the pressure-type co-electrolysis module according to an embodiment of the present invention was initiated, changes in pressure of the pressurized chamber and the inner part of the co-electrolysis cell were illustrated in FIG. 7, and changes in flow rate of the fuel gas and the steam respectively supplied to the pressurized chamber and the co-electrolysis cell were illustrated in FIG. 8.

From experimental results, as per the pressure-type co-electrolysis module according to an embodiment of the present invention, it could be verified that the differential pressure between the inner part of the co-electrolysis cell and the pressurized chamber converged into 0 over time.

Further, operating the pressure-type co-electrolysis module while increasing the pressure of the co-electrolysis module at the increment of 1 in a range from 1 atmosphere to 5 atmospheres exhibited the result illustrated in FIG. 9.

As the result of the operation, it could be verified that the higher pressure was applied upon operation, the lower overpotential showed up.

Although the technical spirit of the present invention has been described with reference to the accompanying drawings, the preferable embodiments of the present invention are provided merely as examples, and the scope of the present invention should not be limited thereto. Rather, it should be appreciated by one of ordinary skill in the art that various changes or derivations may be made thereto without departing from the scope of the present invention.

1. A pressure-type co-electrolysis module, comprising:
a co-electrolysis cell using a fuel gas comprising hydrogen, nitrogen, and carbon dioxide;
a pressurized chamber for pressurizing the co-electrolysis cell; and
an evaporator for providing steam to the co-electrolysis cell.

2. The pressure-type co-electrolysis module of claim 1, comprising:
a mass flow rate controller capable of controlling a mass flow rate of each of the hydrogen, the nitrogen, and the carbon dioxide.

3. The pressure-type co-electrolysis module of claim 1, wherein the co-electrolysis cell is a tube-type co-electrolysis cell.

4. The pressure-type co-electrolysis module of claim 3, wherein the rube-type co-electrolysis cell comprises:
a cylindrical support;
a cathode layer formed on a surface of the cylindrical support;
a solid electrolyte layer formed on a surface of the cathode layer; and
an anode layer formed on a surface of the solid electrolyte layer.

5. The pressure-type co-electrolysis module of claim 4, wherein the cathode layer comprises (Sr₁₋ₓLaₓ)(Ti_{1-y}M_{y})O₃ (M=V, Nb, Co, Mn).

6. The pressure-type co-electrolysis module of claim 3, comprising a heating device for heating the tube-type co-electrolysis cell inside the pressurized chamber.

7. The pressure-type co-electrolysis module of claim 3, further comprising a differential pressure adjustment system for adjusting a differential pressure between the tube-type co-electrolysis cell and the pressurized chamber.

8. The pressure-type co-electrolysis module of claim 7, wherein the differential pressure adjustment system comprises:
a first valve provided in an air injecting part for injecting air to an inner part of the pressurized chamber;
a pressure gauge provided in an air exhausting part for exhausting air from the pressurized chamber;
a pressure adjustor provided between the air injecting part and the air exhausting part;
a second valve provided in a fuel injecting part for injecting the fuel gas and steam to the co-electrolysis cell;
a differential pressure gauge measuring a differential pressure between the air exhausting part and an exhausting part of the co-electrolysis cell for exhausting gas from lite co-electrolysis cell after reaction; and
a differential pressure adjuster connected to the second valve.

9. The pressure-type co-electrolysis module of claim 8, further comprising a buffer chamber provided in the exhausting part of the co-electrolysis cell.

10. The pressure-type co-electrolysis module of claim 8, wherein a pressure of the pressurized chamber is adjusted using the pressure adjusted and the differential pressure between the pressurized chamber and the co-electrolysis cell is adjusted using the differential pressure adjuster.

11. The pressure-type co-electrolysis module of claim 8, wherein the first valve is adjusted so that the pressure of the pressurized chamber is 4 bar to 10 bar.

12. The pressure-type co-electrolysis module of claim 8, wherein the second valve is adjusted so that the differential pressure between the pressurized chamber and the co-electrolysis cell is 0.3 bar or less.

13. A method of operating, under pressure, the pressure-type co-electrolysis module of claims 8, comprising:
measuring a pressure of the pressure gauge;
setting a pressure of the pressure adjustor;
adjusting the first valve according to the set pressure;
setting a differential pressure of the differential pressure adjustor; and
adjusting the second valve according to the set differential pressure.

14. The method of claim 13, wherein the pressure of the pressure adjustor is set to 4 bar to 10 bar.

15. The method of claim 13, wherein the differential pressure of the differential pressure adjustor is set to 0.3 bar or less.
